(19) United States
(12) Patent Application Publication
(10) Pub. No.: US 2012/0052109 A1
(43) Pub. Date: Mar. 1, 2012

(54) Control of Parasites

(75) Inventors: Max Watkins, Hampshire (GB); John Dowrick, Hampshire (GB)

(73) Assignee: VITA (EUROPE) LIMITED, Basingstoke, Hampshire (GB)

(21) Appl. No.: 13/132,303

(22) PCT Filed: Dec. 2, 2009
(86) PCT No.: PCT/GB2009/002811

§ 371 Date: Nov. 16, 2011

(30) Foreign Application Priority Data
Dec. 2, 2008 (GB) GB0822000.6

(51) Int. Cl. A01N 25/34; A01N 43/78; B32B 37/02; A01N 37/06; A01P 7/02; B32B 37/14; A01N 25/00; A01N 37/52

(52) U.S. Cl. 424/443; 424/400; 514/370; 514/636; 514/546; 156/60; 156/280

(57) ABSTRACT

The invention concerns a composition for the treatment of varroa mite infestations in honeybee colonies, comprising a base layer and an active layer, wherein the active layer comprises an effective amount of an acaricidal compound.

### FIELD

The present invention concerns a composition for presenting materials into honeybee colonies to efficiently aid in the appropriate release of said materials for the control of parasitic varroa mite infestations of honeybee colonies.

### BACKGROUND

Varroosis is an infestation of European honeybee colonies (Apis mellifera) with the ectoparasitic mite Varroa destructor, and related species belonging to the order Acari.

The varroa mite originated in Asia and from there has spread to virtually all countries where beekeeping with A. mellifera is practised. In addition, other acarine infestations such as those of Acarapis woodii (Tracheal mite) and Tropilaelaps clareae can cause significant damage to honeybee colony health.

The varroa mites feed off the haemolymph of the developing bees and adults alike and can result in stunted growth of bees, infection and death of bee colonies. Indeed varroa infestation is the most serious threat to beekeeping world-wide today.

Various treatments are available for the control of this disease. However, in certain countries the varroa mite has developed a resistance to the active ingredient of some of these various treatments, notably to products based on the pyrethroids flumethrin, tau-fluvalinate and acrinathrin, and organophosphates such as coumaphos, chlorfenvinphos and related molecules.

Active Pharmaceutical Ingredients, referred to herein as API or active ingredients, have been administered to honeybee colonies in a number of methodologies, depending on the mode of action of the substance. Products have been formulated as additives to feed, usually presented in sugar-syrup to bees; as powders or gels, which the adult bees have to make contact with; and there are some examples of incorporation of API into the matrix of polymer strips where bees come into contact with API exuding to the polymer strip surface.

Solid formulation bases such as strips are simple to apply but the current presentations have been formulated to contain an excess of API, far more than is required for the treatment of the disease. When the API is co-mixed in with the polymer and extruded as a strip, a high loading of API is needed in order for sufficient material to leach out from the polymer reservoir to the strip surface, thus becoming available to the bees. To create this egress of material to the strip surface necessitates a high dosage of API within the strip itself. This can lead to overdosing, promoting mite resistance and high residues in the bee products. The use of large amounts of active ingredients also adds significantly to the costs of producing such strips.

There is a need, therefore, for a new treatment device for varroa and other hive infestations. In particular there is a need for a formulation which can provide delivery of the active ingredient to the bee colony over a substantial period of time using a reduced amount of the active ingredient.

### SUMMARY OF THE INVENTION

Accordingly, in a first aspect the invention provides a composition for the treatment of varroa mite infestations in honeybee colonies, comprising a base layer and an active layer, wherein the active layer comprises an effective amount of an acaricidal compound.

By providing the active agent (i.e. acaricidal compound) in a separate layer, the amount of active agent can be reduced considerably compared to, for example, polymer strips where the active agent is impregnated into the polymer.

In a further possible embodiment, the composition comprises a coating layer which overlies the active layer. The coating layer typically functions to provide a protective surface which reduces abrasion of the active layer, for instance during manufacture and/or transit of the product. This prevents loss of active ingredient before introduction of the composition into a bee colony, and also reduces the rate of egress of the acaricide when in use in the colony. However, the coating layer is preferably formed such that the coating layer can be slowly abraded whilst in use, thereby controlling release of the active ingredient into the hive. In specific embodiments, the coating layer may be formed from a material such as cellulose, silica, polyethyl glycol or a wax. Typically this coating layer does not comprise an active agent (e.g. acaricidal compound).

Thus the compositions of the present invention are typically laminated products, i.e. they consist of formulations comprising two or more distinct layers as described herein. Each of the layers may be formed from the same or different basic materials. Typically the layers formed from different materials as determined by their differing functions. In some embodiments each layer may be formed from the same basic material (e.g. cellulose), although the active layer is typically distinct in that it comprises the active agent. Preferably the compositions are in the form of a strip, band or plate, or any other flat laminated structure.

Typically the base layer functions to provide support to the active layer. Thus in one embodiment the base layer is formed from a rigid material, such that the base layer provides support to the active layer and optionally also the coating layer. For example, the base layer may comprise or consist essentially of cellulose, plastic (e.g. polyester) or metal (e.g. aluminium). Preferably the base layer does not comprise an acaricidal compound, i.e. the base layer substantially lacks an active agent. This avoids the need for excess active agent to be used in the manufacture of the product.

The active agent (i.e. acaricidal compound) may be any known agent which is effective against mites, particularly the Varroa mite, Varroa destructor and related species. Preferably the active agent has low or no insecticidal activity, i.e. has low or no toxicity against honeybees (Apis mellifera). As used herein, the term “acaricidal compound” includes semiochemicals (e.g. pheromones) used in controlling mite infestations.

In one embodiment the acaricidal compound comprised in the active layer is selected from the group consisting of cis-8-dodecenyl acetate, 1-dodecanol, n-hexadecyl acetate, n-octadecyl acetate and methyl palmitate.

In another embodiment, the acaricidal compound is a compound or mixture of compounds as disclosed in WO97/47193, e.g. an essential oil or an organic acid. Examples of essential oils are monoterpenes, such as menthol, geraniol, thymol, myrcene, citral, limonene, carene, camphor, eugenol, or cineol (eucalyptol); and natural oils such as lemon oil, eucalyptus oil, or neem oil. Examples of organic acids include acids such as formic acid, acetic acid or oxalic acid.

In another embodiment the acaricidal compound is a pyrethroid, or an amidine or related compound, such as flumethrin, fluvalinate, acrinathrin, amitraz, cymiazole hydrochloride, bromopropylate or fenpyroximate.

The active layer comprises the acaricidal compound and is typically disposed on the surface of the base layer. In one, embodiment the active layer is formed from an inert material, such that the acaricidal compound can be applied to the active layer in a solvent. In specific embodiments, the active layer comprises cellulose, silica, polyethyl glycol or a wax.

In another aspect, the invention provides a method for the treatment of varroa mite infestations in colonies of honeybees, comprising applying a composition as defined above to the locus of the honeybee colonies.

The compositions of the present invention preferably provide for slow or controlled release of the active agent. Thus the concentration of the composition in the environment of the bee colony is preferably kept at an efficacious level over a period of at least 1 month, and preferably up to 2 months.

In another aspect, the invention provides a method for the preparation of a composition as defined above, comprising the base layer; and applying the active layer to the base layer; wherein the acaricidal compound is incorporated into the active layer before or after application of the active layer to the base layer.

In one embodiment the acaricidal compound is incorporated into the active layer by absorption of a solution containing the acaricidal compound into the active layer. For instance, the active agent may first be dissolved in an appropriate solvent (e.g. an organic solvent or water) and then the solution formed is applied to the active layer. In one embodiment the active layer is dipped or bathed in the solution to allow the solution to be absorbed. The solvent may optionally be removed, for instance in the case of a volatile solvent by evaporation or drying.

The acaricidal compound may be incorporated into the active layer before or after the active layer is applied to the base layer. However, if the base layer is absorbent it is possible to incorporate the active agent first (e.g. by dipping or bathing as mentioned above) before contacting with the base layer. This avoids the uptake of the active agent by the base layer. In an alternative embodiment where the base layer is non-absorbent, the base layer may first be applied to the active layer and then the active agent incorporated by application in a solution.

The active layer may be applied to the base layer by any suitable technique. In one embodiment the active layer is applied to the base layer by rolling.

The coating layer, if needed, may be applied onto the active layer by any suitable technique. In one embodiment the coating layer is applied by spraying, e.g. the coating layer material is provided in a liquid form (e.g. in a solution with an appropriate solvent), the liquid is sprayed onto the active layer and then allowed to dry.

### DETAILED DESCRIPTION OF THE INVENTION

For the purpose of this invention, the locus of colonies of honeybees is usually understood, but not limited, to beehives, or similar containers where colonies of bees build their breeding places, such as honeycombs. Preferably, the locus of honeybee colonies as referred to herein is a beehive.

### Compositions

A composition according to the present invention comprises two or more layers. Each layer may consist of a pure compound or a mixture of compounds presented in a specific formulation type. Compositions according to the invention are typically formulated from high purity starting materials, available commercially from specialist manufacturers. The preparation may also include an anti-oxidant such as butylated hydroxytoluene (BHT), 2,6-Bis(1,1-dimethyl-ethyl)-4-methylphenol.

An “effective amount” of a compound component of the composition according to the present invention is an amount which, in the relevant formulation, is sufficient for effective control of varroa mite infestations, as defined below.

In addition, each layer of the composition may include one or more excipients, which may be solvents, thickeners, and the like.

In a preferred embodiment, methods according to the present invention comprise the application of only a single API. Alternatively, however, mixtures of two or more APIs may be used. Optionally, the method may entail the application of a mixture of substances.

In one embodiment, the compositions consist of a thin solid base, made of, for example cellulose, polyester, acrylic or other polymers, aluminium or other metal. The base is to provide rigidity to the formulation for placement and durability in the hive. The thickness of the base layer may be selected according to, for example, the nature of material used, but may typically be in the region of, for example 0.1 to 3 mm, e.g. 0.2 to 2 mm.

To the base can be adhered a second layer, typically comprising a thin layer of absorbent material, for example, a polymer such as cellulose, silica or polyethyl glycol or other waxes such as beeswax, bee propolis and the like. The second (active) layer may be applied by, for example, rolling onto the base layer and optionally exerting a downward pressure to compress the two layers together. The Active Pharmaceutical Ingredient may be solved or adhered to this active material layer. In one embodiment the active layer is formed from silica gel sheets or strips which are soaked in a solution containing the active agent, then applied to a solid base layer. The thickness of the active layer may be, for example, 10 to 1000 microns (μm), e.g. 20 to 500 μm.

Possibly, a third layer of a thin coat of, for example cellulose, polyethyl glycol or other waxes is applied over the second layer, thus encasing the active layer including the API in a laminate type strip or plate device. The third layer may be applied by, for example, spraying on the coating layer material in a liquid form and drying.

Laminated structures are devices which often have optimum release characteristics, approaching zero order (constant) release.

### Dispensing the Active Agent

The compositions of the present invention provide a new type of dispenser which has several advantages over current treatment regimes. Generally, a dispenser may be any medium suitable for dispersing a composition according to the present invention characterised in that it provides a more regulated administration of active material over a given time-frame in comparison to raw active material. In particular, such are preferably capable of providing a relatively constant concentration of the API in the environment of a bee habitat, i.e. a beehive during the period of treatment.

The active agent comprised in the active layer of the composition of the invention is transported from the composition via the solid phase or via the vapour phase to the varroa mites, depending on the active material used. In a preferred aspect of the invention, a solid composition is eroded from the surface of the strip or plate by the honeybees or in the case of more volatile substances, evaporates or sublimates from the dispenser in a regulated concentration into the atmosphere of the bee environment (e.g. the beehive) and maintains the preselected concentration for at least a one month treatment period. Though the atmosphere in the bee environment is not hermetically sealed, the population increase of the varroa mites in said environment can be effectively controlled by the release of the composition from the dispenser.

The method of control of varroa infestations according to the present invention is both effective against acaricide-resistant and acaricide-susceptible varroa mite strains in beehives. In a preferred embodiment of the invention, effective control of mite populations, particularly varroa populations, may be achieved such that the infestation is reduced to a level of 20% or less of a starting infestation level. The “starting infestation level” is the infestation level before treatment is initiated. Preferably, the reduction in infestation levels to 20% is achieved within two months. Advantageously, varroa populations are reduced by between 70% and 100%, and preferably between 80% and 95%. At higher dispenser loadings in particular, the invention is capable of reducing varroa mite populations by at least 80%, preferably to 90% and optimally about 95%.

### Control of Varroa Mites

The present invention is effective in the control of varroa mites in the presence of bee brood. In the normal varroa life cycle, fecund female varroa mites enter the cells of the brood before they are capped over by the worker bees. After a period of rest the female mite begins to feed off the developing bee pupa and only then can lay eggs.

In the presence of compositions according to the invention, the mites that are not within the capped brood cells are subject to free treatment materials circulating in the hive. Bees pick up a known amount of active ingredient from the surface of the new device and transfer it between nest-mates. Mites coming into proximity or contact with bees receive a dose of API and will die. Those mites already within the capped brood cells are protected from treatment; the treatment therefore has to have a residual life so that product is still available to the mites when they eventually emerge from the brood cells, when the young bees hatch out. The device as described, holds the API for a sufficient period to cover two life cycles of Varroa mite within the hive. After that time the device loading is depleted.

Thus, the invention successfully and efficiently limits varroa mite populations using low quantities of API.

In order to achieve the treatment of varroa mite infestations, release of the composition should take place over a period of a minimum of six weeks. Preferably, the composition is released over a period of two months. This requires the dispenser to contain between 0.1 mg and 1000 mg of the active ingredient, the level of which depends upon the API chosen. Preferably, the composition contains between 100 mg to 300 mg of the active ingredient (acaricidal compound).

In accordance with the present invention, the term “treatment” means the reduction of the numbers of the mites which infest the honeybee colonies. Thus, compositions according to the invention are effective to limit population growth of the mites and, directly or indirectly, cause the death thereof. The compositions do not merely function as attractants, requiring the presence of other agents to provide control of the mite population.

The invention is further described below, for the purpose of illustration only, in the following examples.

### EXAMPLE 1

### Preparation of an Acaricide-Containing Composition

Cymiazole, (or in alternative embodiments cymiazole hydrochloride, or other imidazoles, amidines or cis-8-dodecenyl acetate) is dissolved in a suitable solvent. The solution is applied by pipette to Polygram® silica gel-coated polyester sheets (Macherey-Nagel, Duren, Germany) thus allowing the active agent to be absorbed into the silica gel. The sheets comprise a non-absorbent polyester base layer approximately 0.2 mm thick, and have dimensions of approximately 20 cm×5 cm. After soaking, the sheets are dried and can be sprayed with an aqueous solution comprising ethyl cellulose, or similar, followed by a further drying step.

The starting materials (individual Active Pharmaceutical Ingredients) are obtained commercially in a highly pure form. A solution of the APIs is made up as a loading solution.

### EXAMPLE 2

### Biological Test

Compositions prepared as described in Example 1 are placed in a beehive on top of the brood frames. The test is started by placing the sheets in the beehives, and is continued for 6 weeks. The average temperature inside and outside the beehives is recorded.

After 4 to 6 weeks, the mite infestation of the bee colony is assessed in comparison to an untreated control beehive by counting the total number of mites killed during the treatment and divided by the same total plus the number of mites falling after a final treatment with a known effective acaricide, killing all surviving mites.

All publications mentioned in the above specification are herein incorporated by reference. Various modifications and variations of the described methods and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

1. A composition for the treatment of varroa mite infestations in honeybee colonies, comprising a base layer and an active layer, wherein the active layer comprises an effective amount of an acaricidal compound.

2. A composition according to claim 1 which is in the form of a laminated strip, band, sheet or plate.

3. A composition according to claim 1, wherein the base layer is formed from a rigid material, such that the base layer provides support to the active layer and optionally a coating layer.

4. A composition according to claim 3, wherein the base layer comprises a metal or a natural or man-made polymer, preferably cellulose or a plastic.

5. A composition according to claim 4, wherein the base layer comprises polyester or aluminium.

6. A composition according to claim 1, wherein the base layer does not comprise an acaricidal compound.

7. A composition according to claim 1, wherein the acaricidal compound comprised in the active layer is selected from the group consisting of: cymiazole, amitraz, cis-8-dodecenyl acetate, 1-dodecanol, n-hexadecyl acetate, n-octadecyl acetate, methyl palmitate, 2-heptanone, eugenol, thymol, methyl cresol, tau-fluvalinate, peracetic acid, formic acid and oxalic acid.

8. A composition according to claim 1, wherein the acaricidal compound is an amidine or an imidazole, preferably cymiazole or amitraz.

9. A composition according to claim 1, wherein the active layer is formed from a material such that the acaricidal compound can be applied and adhered to the active layer in a solvent.

10. A composition according to claim 1, wherein the active layer comprises cellulose, silica, polyethyl glycol or a wax in addition to the acaricidal compound.

11. A composition according to claim 1, further comprising a coating layer which overlies the active layer.

12. A composition according to claim 11, wherein the coating layer provides a protective surface which reduces abrasion of the active layer.

13. A composition according to claim 11, wherein the coating layer comprises cellulose, silica, polyethyl glycol or a wax.

14. A composition according to claim 1, which is capable of delivering an effective amount of the composition over a period of up to two months.

15. A method for the treatment of varroa mite infestations in colonies of honeybees, comprising applying a composition as defined in any preceding claim to the locus of the honeybee colonies.

16. A method according to claim 15, wherein the concentration of the composition in the environment of the bee colony is kept at an efficacious level over a period of up to 2 months.

17. A method for the preparation of a composition as defined in claim 1, comprising:
(a) providing the base layer; and
(b) applying the active layer to the base layer;
wherein the acaricidal compound is incorporated into the active layer before or after application of the active layer to the base layer.

18. A method according to claim 17, wherein the acaricidal compound is incorporated into the active layer by absorption of a solution containing the acaricidal compound into the active layer.

19. A method according to claim 17, further comprising applying a coating layer onto the active layer by spraying.
